(19) United States
(12) Patent Application Publication
(10) Pub. No.: US 2026/0111266 A1
(43) Pub. Date: Apr. 23, 2026

(54) CODE SHARING METHOD AND APPARATUS, SWITCH, MULTI-HOST SYSTEM, DEVICE, AND MEDIUM

(71) Applicant: Suzhou MetaBrain Intelligent Technology Co., Ltd., Suzhou, Jiangsu (CN)

(72) Inventors: Qingwei ZHAI, Suzhou, Jiangsu (CN); Xinglong WANG, Suzhou, Jiangsu (CN); Jinfeng LI, Suzhou, Jiangsu (CN)

(21) Appl. No.: 19/168,473

(22) PCT Filed: Sep. 29, 2024
(86) PCT No.: PCT/CN2024/122149

§ 371 Date: Sep. 24, 2025

(30) Foreign Application Priority Data
Jan. 31, 2024 (CN) 202410130587.1

(51) Int. Cl. G06F 9/50

(52) U.S. Cl. CPC G06F 9/5016

(57) ABSTRACT

The present application provides a code sharing method and apparatus, a switch, a multi-host system, a device, and a medium. The method includes: determining to enable a system management mode of a current host; sending a system management mode initialization request to a switch in a multi-host system, where the switch is configured to determine, based on the system management mode initialization request, a target shared memory module for storing system management mode code among a plurality of shared memory modules in the multi-host system, and a system management random access memory area corresponding to the system management mode code in the target shared memory module, and establish a data connection between the current host and the target shared memory module; and initializing the system management mode of the current host based on the system management mode code.

### CROSS-REFERENCE TO RELATED APPLICATION

This application claims priority to Chinese Patent Application No. 2024101305871, filed on Jan. 31, 2024 in China National Intellectual Property Administration and entitled “Code Sharing Method and Apparatus, Switch, Multi-Host System, Device, and Medium”, which is hereby incorporated by reference in its entirety.

### FIELD

The present application relates to a code sharing method and apparatus, a switch, a multi-host system, a device, and a medium.

### BACKGROUND

With the development of server technology, multi-host systems have been increasingly widely used. In a multi-host system, in order to enable each host to implement a system management mode (SMM), a dedicated system management random access memory needs to be provided in a memory of each host to store code related to the system management mode. When a plurality of hosts stores the same code, the entire system requires a large amount of memory resources to store the same code, resulting in waste of memory resources in the system. In addition, the waste of memory resources intensifies with the increase of hosts.

Therefore, the inventor realized that how to improve the utilization of memory resources in the multi-host system and reduce the hardware configuration cost of the multi-host system has become an urgent technical problem in the industry.

### SUMMARY

In a first aspect, an embodiment of the present application provides a code sharing method, which is applied to hosts in a multi-host system and includes:
determining to enable a system management mode of a current host;
sending a system management mode initialization request to a switch in the multi-host system, where the switch is configured to determine, based on the system management mode initialization request, a target shared memory module for storing system management mode code among a plurality of shared memory modules in the multi-host system, and a system management random access memory area corresponding to the system management mode code in the target shared memory module, and establish a data connection between the current host and the target shared memory module; and
initializing the system management mode of the current host based on the system management mode code.

In a second aspect, an embodiment of the present application provides a code sharing method, which is applied to a switch in a multi-host system and includes:
in response to a system management mode initialization request sent by a current host in the multi-host system, determining a target shared memory module for storing system management mode code among a plurality of shared memory modules, and a system management random access memory area corresponding to the system management mode code in the target shared memory module; and
establishing a data connection between the current host and the target shared memory module, whereby the current host initializes a system management mode based on the system management mode code.

In a third aspect, an embodiment of the present application provides a code sharing apparatus, which is applied to hosts in a multi-host system and includes:
an enable unit, configured to determine to enable a system management mode of a current host;
a request unit, configured to send a system management mode initialization request to a switch in the multi-host system, where the switch is configured to determine, based on the system management mode initialization request, a target shared memory module for storing system management mode code among a plurality of shared memory modules in the multi-host system, and a system management random access memory area corresponding to the system management mode code in the target shared memory module, and establish a data connection between the current host and the target shared memory module; and
an initialization unit, configured to initialize the system management mode of the current host based on the system management mode code.

In a fourth aspect, an embodiment of the present application provides a code sharing apparatus, which is applied to a switch in a multi-host system and includes:
a response unit, configured to, in response to a system management mode initialization request sent by a current host in the multi-host system, determine a target shared memory module for storing system management mode code among a plurality of shared memory modules, and a system management random access memory area corresponding to the system management mode code in the target shared memory module; and
a connection unit, configured to establish a data connection between the current host and the target shared memory module, whereby the current host initializes a system management mode based on the system management mode code.

In a fifth aspect, an embodiment of the present application provides a switch, including the code sharing apparatus in the third aspect or the fourth aspect.

In a sixth aspect, an embodiment of the present application provides an electronic device, including a memory, a processor, and computer-readable instructions stored in the memory and executable on the processor, the processor, when executing the computer-readable instructions, implementing the code sharing method in the first aspect or the second aspect.

In a seventh aspect, an embodiment of the present application provides a non-transitory computer-readable storage medium, having computer-readable instructions stored therein, the computer-readable instructions, when executed by a processor, implementing the code sharing method in the first aspect or the second aspect.

Details of one or more embodiments of the present application are proposed in the accompanying drawings and descriptions below. Other features and advantages of the present application will become apparent from the description, drawings, and claims.

### BRIEF DESCRIPTION OF THE DRAWINGS

The accompanying drawings herein are incorporated into the description and constitute a portion of the description, show embodiments in accordance with the present application, and are used with the description to explain the principles of the present application. In order to describe the technical solutions in the present application or in the related art more clearly, the accompanying drawings required in the description of the embodiments or the related art will be briefly introduced below. Apparently, the drawings in the following description represent merely some embodiments of the present application. A person skilled in the art may derive other drawings from these drawings without any creative efforts.

FIG. 1 is a first schematic flowchart of a code sharing method provided in an embodiment of the present application;

FIG. 2 is a second schematic flowchart of a code sharing method provided in an embodiment of the present application;

FIG. 3 is a system architecture diagram of a multi-host system provided in an embodiment of the present application;

FIG. 4 is a schematic flowchart of a multi-host code sharing method provided in an embodiment of the present application;

FIG. 5 is a first schematic structural diagram of a code sharing apparatus provided in an embodiment of the present application;

FIG. 6 is a second schematic structural diagram of a code sharing apparatus provided in an embodiment of the present application;

FIG. 7 is a schematic structural diagram of a switch provided in an embodiment of the present application;

FIG. 8 is a schematic structural diagram of a multi-host system provided in an embodiment of the present application;

FIG. 9 is a schematic structural diagram of an electronic device provided in an embodiment of the present application; and

FIG. 10 is a schematic structural diagram of a non-transitory computer-readable storage medium provided in an embodiment of the present application.

### DETAILED DESCRIPTION

In order to make a person skilled in the art better understand the solutions of the present application, the technical solutions in the embodiments of the present application will be clearly and completely described below in conjunction with the accompanying drawings therein. Apparently, the described embodiments are merely part of the embodiments of the present application, not all of them. Based on the embodiments of the present application, all other embodiments obtained by a person skilled in the art without any creative efforts should fall within the scope of protection of the present application.

It should be noted that the terms “first”, “second”, etc. in the present application are used to distinguish similar objects and do not necessarily describe a specific order or sequence. Data used in this way may be interchanged in appropriate circumstances, whereby the embodiments of the present application described herein might be implemented in order other than those illustrated or described herein. In addition, the terms “include”, “have”, and any other variant thereof are intended to cover a non-exclusive inclusion. For example, a process, method, system, product, or device that includes a list of steps or units is not necessarily limited to those steps or units that are expressly listed, but may include other steps or units that are not expressly listed or are inherent to the process, method, system, product, or device.

A system management mode (SMM) is a special working mode of a central processing unit (CPU) in a host. In this mode, a highest privilege level is provided, and various privileged instructions and input output (IO) operations may be executed. Server firmware triggers a system management interrupt (SMI) to cause the CPU to enter the SMM and then execute SMM code. Current SMM code is fixedly stored in a system management random access memory (SMRAM) area of a memory. The memory area is initialized and locked by a basic input output system (BIOS) in a startup phase to ensure that the memory area is invisible to the system and might not be read or written. Only after the SMI is triggered, might this area be read or written through the BIOS.

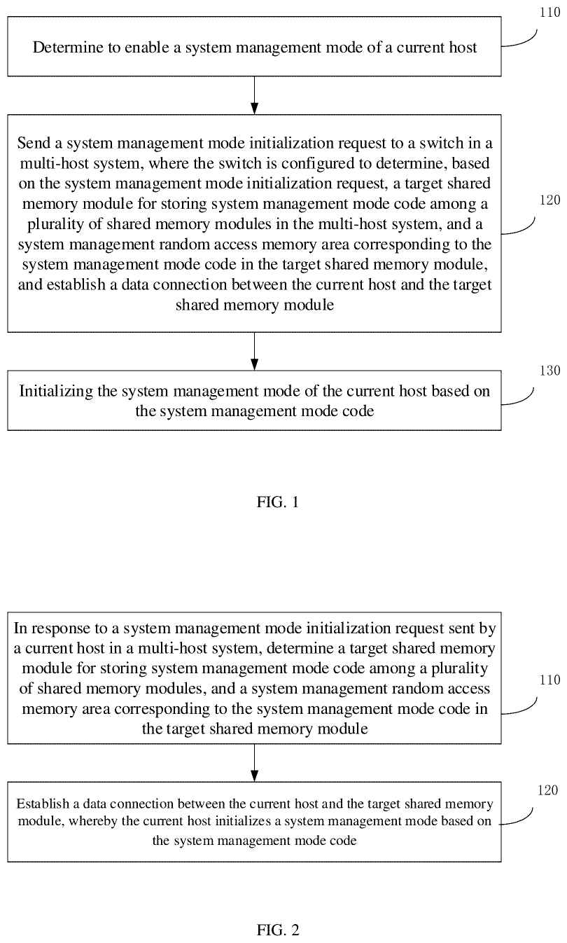

FIG. 1 is a first schematic flowchart of a code sharing method provided in the present application. As shown in FIG. 1, the method includes steps 110, 120, and 130.

Step 110: determining to enable a system management mode of a current host.

In some embodiments, the host refers to a computer or server that bears and manages other devices or services, such as a computer running server software and providing services. A web server, a database server, a file server, and the like are all hosts. A shared memory module refers to a remote memory independent of a local memory of the host. The local memory is directly connected to a processor in the host, and the shared memory module is configured to expand the memory usage of the host. A switch refers to a device that connects the host to the shared memory module to forward data. A quantity of hosts and a quantity of shared memory modules in a multi-host system are not in some embodiments limited in the embodiments of the present application.

The executive subject of the method provided in the embodiments of the present application is a code sharing apparatus in the host. The apparatus may be implemented through software, such as a code sharing program running in a basic input output system (BIOS) of the host; or the apparatus, such as a basic input output system chip, may perform the code sharing method.

The current host refers to a host that needs to initialize the system management mode in the multi-host system. A user may enable or disable the system management mode of the current host by inputting setting information in the basic input output system when the host starts. The system management mode is a high-priority, high-privilege mode configured to handle tasks and events related to system management, and may comprehensively control and manage system hardware of the host.

Step 120: sending a system management mode initialization request to a switch in the multi-host system, where the switch is configured to determine, based on the system management mode initialization request, a target shared memory module for storing system management mode code among a plurality of shared memory modules in the multi-host system, and a system management random access memory area corresponding to the system management mode code in the target shared memory module, and establish a data connection between the current host and the target shared memory module.

In some embodiments, to initialize the system management mode, the current host needs to acquire the system management mode code, i.e., a system management mode handler (SMM handler). In the related art, the system management mode handler is usually stored in a local memory of each host. The local memory is directly connected to a processor of the host. When a plurality of hosts stores the same system management mode code, the entire multi-host system requires a large amount of memory resources to store the same code, resulting in waste of memory resources in the system. In addition, the waste of memory resources intensifies with the increase of hosts.

In the embodiment of the present application, the system management mode code may be stored in the shared memory module and shared by the plurality of hosts. In this case, the system management mode code is not stored in the local memory of each host, but is acquired from the shared memory module.

The target shared memory module is a shared memory module for storing the system management mode code. The target shared memory module includes a plurality of memory areas, and any of the memory areas may serve as a system management random access memory (SMRAM) area.

The current host may send the system management mode initialization request to the switch in the multi-host system, the request being configured for indicating that the current host will initialize the system management mode and requests to acquire the system management mode code.

Upon receiving the system management mode initialization request, the switch parses the request, and determines the target shared memory module for storing the system management mode code among the plurality of shared memory modules in the multi-host system, and the system management random access memory area corresponding to the system management mode code in the target shared memory module.

Location information of the target shared memory module and location information of the system management random access memory area may be stored in the switch after being created, or stored to a set location in the plurality of shared memory modules, and read by the switch or each host at startup.

After determining the locations of the target shared memory module and the system management random access memory area, the switch may establish the data connection between the current host and the target shared memory module, whereby the current host might access the target shared memory module to acquire the system management mode code.

Step 130: initializing the system management mode of the current host based on the system management mode code.

In some embodiments, the current host initializes the system management mode based on the data connection established by the switch.

The system management mode might only be entered through system management interrupt (SMI).

Initializing the system management mode refers to configuring the system management mode in an available state in the host startup process, and preparing corresponding resources and environment to enter the system management mode for system management and processing when needed.

A process of initializing the system management mode usually includes the following operations.

When the host starts, the BIOS detects and configures SMM functions, enables SMM by configuring a corresponding register and flag, and ensures that the processor might enter an SMM operating mode.

In the system management random access memory area (also known as SMM space), the system management mode code, i.e., an SMM program and processing logic, needs to be loaded, where the functions of SMM include system management, power management, temperature monitoring, etc. After the SMM code is loaded, the system might switch to the SMM when needed.

The SMM may need to access and control hardware devices in the system, such as a clock, a power manager, and a temperature sensor. In the SMM initialization process, these devices need to be configured and initialized to ensure that the SMM might communicate and interact with them normally.

The SMM needs to handle various hardware events and exceptions, such as clock interrupt, power events, and system wake-up. In the SMM initialization phase, an interrupt and exception handling mechanism needs to be configured to respond and handle these events correctly when needed.

By completing the above initialization step, the SMM might be in an available state and prepare for subsequent system management tasks. Once the system enters the SMM, the SMM might independently perform corresponding system management functions without being affected by ordinary operating systems.

The code sharing method provided in the embodiment of the present application, applied to the multi-host system, includes: determining to enable the system management mode of the current host; sending the system management mode initialization request to the switch in the multi-host system, where the switch is configured to determine, based on the system management mode initialization request, the target shared memory module for storing system management mode code among the plurality of shared memory modules in the multi-host system, and the system management random access memory area corresponding to the system management mode code in the target shared memory module, and establish the data connection between the current host and the target shared memory module; and initializing the system management mode of the current host based on the system management mode code. Since the shared memory modules are configured in the multi-host system and the system management mode code is stored in the shared memory modules, each host may access and initialize the system management mode, and the same code does not need to be stored in the local memory of each host, thereby saving memory resources in the multi-host system, avoiding waste of memory resources, and improving the utilization of memory resources in the multi-host system. Meanwhile, the quantity and capacity of the shared memory modules may be flexibly configured according to the needs of the multi-host system, thereby reducing hardware configuration costs of the multi-host system.

It should be noted that each implementation of the present application may be freely combined, swapped in order, or executed separately, without relying on a fixed execution order.

In some embodiments, the initializing the system management mode of the current host based on the system management mode code includes:
acquiring an initialization detection result of the system management random access memory area;
when the initialization detection result is initialized, reading the system management mode code in the system management random access memory area;
verifying the system management mode code; and
when a verification result of the system management mode code is passed, loading the system management mode code to initialize the system management mode of the current host.

In some embodiments, the host may acquire the initialization detection result of the system management random access memory area. The purpose of initializing the system management random access memory area is to configure the system management random access memory area in an available state, whereby the host might correctly read-write data.

When the initialization detection result is initialized, it indicates that the host might correctly read-write data in the system management random access memory area. The host might read the system management mode code and verify the code.

Verifying the system management mode code refers to verifying and checking the code loaded in the system management random access memory area to ensure its integrity and security. In the system startup process, the system management mode code is loaded into the system management random access memory area. The code is configured for implementing system management functions, such as power management and temperature monitoring. Due to the privileged access permission of the system management mode code, its security is crucial. Verifying the system management mode code might help prevent the execution of malicious code and other security threats. The verification content may include integrity verification, security verification, credibility verification, etc.

If the verification result of the system management mode code is passed, the system management mode code is loaded to initialize the system management mode of the current host.

The code sharing method provided in the embodiment of the present application acquires the initialization detection result of the system management random access memory area and verifies the system management mode code, thereby improving the security of host operation.

In some embodiments, after acquiring an initialization detection result of the system management random access memory area, the method further includes:
when the initialization detection result is uninitialized, initializing the system management random access memory area; and
sending system management random access memory area initialization information to the hosts before the current host in a startup sequence.

In some embodiments, in the multi-host system, the plurality of hosts might access the system management random access memory area in the target shared memory module in the startup sequence. Before the current host access, there may be a situation where the system management random access memory area has not been initialized or fails in initialization.

When the initialization detection result is uninitialized, it indicates that the current host might not correctly read-write data in the system management random access memory area.

The current host may initialize the system management random access memory area, including: clearing existing data content to prevent old data from interfering with the system management mode code; configuring a memory mapping table to enable the host to correctly access and manage the system management random access memory area; initializing a memory controller to ensure its normal work and communication with other system components; and self-checking a memory module to detect and correct possible hardware errors or faults.

After the system management random access memory area is initialized, the current host may generate the system management random access memory area initialization information. The information may be configured for prompting that the system management random access memory area has been initialized.

The current host may send the system management random access memory area initialization information to each host before the current host in the startup sequence, so as to prompt each host to initialize the system management mode based on the system management random access memory area that has been initialized.

According to the code sharing method provided by this embodiment, the current host initializes the system management random access memory area when the initialization detection result is uninitialized, and sends the system management random access memory area initialization information to each host before the current host in the startup order, whereby each host in the multi-host system might initialize the system management mode, thereby improving the utilization of memory resources in the multi-host system and improving the success rate of system management mode initialization in each host.

In some embodiments, the method further includes:
sending a system management mode code storage request to the switch, where the switch is configured to establish the data connection between the current host and the target shared memory module based on the system management mode code storage request; and
initializing the system management random access memory area in the target shared memory module, and transferring the system management mode code from a memory module of the current host to the system management random access memory area.

In some embodiments, when the multi-host system starts, the current host may serve as the first host in the system, so the system management random access memory area needs to be initialized.

In the startup phase, the current host may send the system management mode code storage request to the switch. The request is configured for initializing the system management random access memory area in the shared memory module and storing the system management mode code.

The switch may determine the target shared memory module among the plurality of shared memory modules based on the system management mode code storage request, and establish the data connection between the current host and the target shared memory module.

When the target shared memory module is determined among the plurality of shared memory modules, the switch may determine the target shared memory module based on the read-write performance, read-write priority, and storage capacity of each shared memory module. For example, the switch may evaluate the read-write performance of each shared memory module based on storage capacity and read-write speed, sort the shared memory modules in descending order based on evaluation values of the read-write performance of the shared memory modules, and determine the shared memory module at the head of the queue as the target shared memory module.

The current host initializes the system management random access memory area in the target shared memory module through the established data connection, and transfers the system management mode code from the memory module of the current host to the system management random access memory area after initialization. The memory module of the current host refers to the local memory of the current host. The user may pre-store the system management mode code in the memory module of the current host.

According to the code sharing method provided in the embodiment of the present application, the current host may serve as a first startup host to initialize the system management random access memory area of the target shared memory module and store the system management mode code, whereby the following startup hosts may initialize the system management mode, thereby improving the utilization of memory resources in the multi-host system.

In some embodiments, the method further includes:
sending a system management mode code update request to the switch, where the switch is configured to establish a data connection between the current host and the target shared memory module based on the system management mode code update request; and
updating the system management mode code in the system management random access memory area based on system management mode code in a memory module of the current host.

In some embodiments, in the multi-host system, the current host may serve as a code update host in the system to update the system management mode code in the system management random access memory area.

The current host may send the system management mode code update request to the switch. After parsing the received code update request, the switch establishes the data connection between the current host and the target shared memory module.

The current host may acquire first version information corresponding to the system management mode code in the system management random access memory area, and determine second version information corresponding to the system management mode code in the memory module of the current host. Based on a comparison result between the first version information and the second version information, whether to update the system management mode code in the system management random access memory area is determined. For example, when a version number in the first version information is less than that in the second version information, it is determined that the system management mode code in the target shared memory module needs to be updated, and the system management mode code in the memory module of the current host is copied to the target shared memory module to cover the system management mode code in the system management random access memory area, to complete the update.

According to the code sharing method provided in the embodiment of the present application, the current host might be configured to update the system management mode code in the target shared memory module, and the updated system management mode code might be shared by other hosts in the multi-host system, thereby improving the efficiency of updating the system management mode code and enhancing the utilization of memory resources in the multi-host system.

In some embodiments, at least two hosts in the multi-host system use the same system management mode code.

In some embodiments, at least two hosts in the multi-host system use the same system management mode code, so the system management mode code might be stored in the shared memory modules, and the hosts using the same code initialize the system management mode.

The hosts in the multi-host system may be grouped, with different groups using different system management mode code and the same group using the same system management mode code. Based on a quantity of groups, a plurality of shared memory modules may be selected or a plurality of system management random access memory areas may be established within the same shared memory module, whereby the host in each group might have the corresponding system management random access memory area in the shared memory module.

According to the code sharing method provided in the embodiment of the present application, the hosts may be grouped based on the usage of the system management mode code in the hosts, and the corresponding system management random access memory area is established in the shared memory module, whereby each host might complete system management mode initialization based on the shared code in the system management random access memory area, thereby improving the utilization of memory resources in the multi-host system.

FIG. 2 is a second schematic flowchart of a code sharing method provided in the present application. As shown in FIG. 2, the method includes steps 210 and 220.

Step 210: in response to a system management mode initialization request sent by a current host in a multi-host system, determining a target shared memory module for storing system management mode code among a plurality of shared memory modules, and a system management random access memory area corresponding to the system management mode code in the target shared memory module.

Step 220: establishing a data connection between the current host and the target shared memory module, whereby the current host initializes a system management mode based on the system management mode code.

In some embodiments, the executive subject of the method provided in the embodiment of the present application is a code sharing apparatus in the host. The apparatus may be implemented through software, such as a code sharing program running in a switch; or the apparatus, such as a switch, may perform the code sharing method.

The current host needs to acquire the system management mode code to initialize the system management mode. In the related art, the system management mode handler is usually stored in a local memory of each host. The local memory is directly connected to a processor of the host. When a plurality of hosts stores the same system management mode code, the entire multi-host system requires a large amount of memory resources to store the same code, resulting in waste of memory resources in the system. In addition, the waste of memory resources intensifies with the increase of hosts.

In the embodiment of the present application, the system management mode code may be stored in the shared memory module and shared by the plurality of hosts. In this case, the system management mode code is not stored in the local memory of each host, but is acquired from the shared memory module.

The target shared memory module is a shared memory module for storing the system management mode code. The target shared memory module includes a plurality of memory areas, and any of the memory areas may serve as a system management random access memory area.

The current host may send the system management mode initialization request to the switch in the multi-host system, the request being configured for indicating that the current host will initialize the system management mode and requests to acquire the system management mode code.

Upon receiving the system management mode initialization request, the switch parses the request in response to the initialization request, and determines the target shared memory module for storing the system management mode code among the plurality of shared memory modules in the multi-host system, and the system management random access memory area corresponding to the system management mode code in the target shared memory module.

Location information of the target shared memory module and location information of the system management random access memory area may be stored in the switch after being created.

After determining the locations of the target shared memory module and the system management random access memory area, the switch may establish the data connection between the current host and the target shared memory module, whereby the current host might access the target shared memory module to acquire the system management mode code.

The code sharing method provided in the embodiment of the present application, applied to the switch in the multi-host system, includes: in response to the system management mode initialization request sent by the current host in the multi-host system, determining the target shared memory module for storing system management mode code among the plurality of shared memory modules, and the system management random access memory area corresponding to the system management mode code in the target shared memory module; and establishing the data connection between the current host and the target shared memory module, whereby the current host initializes the system management mode based on the system management mode code. Since the shared memory modules are configured in the multi-host system and the system management mode code is stored in the shared memory modules, each host may access and initialize the system management mode, and the same code does not need to be stored in the local memory of each host, thereby saving memory resources in the multi-host system, avoiding waste of memory resources, and improving the utilization of memory resources in the multi-host system. Meanwhile, the quantity and capacity of the shared memory modules may be flexibly configured according to the needs of the multi-host system, thereby reducing hardware configuration costs of the multi-host system.

In some embodiments, the method further includes:
in response to a system management mode code storage request sent by the current host in the multi-host system, determining the target shared memory module among the plurality of shared memory modules; and
establishing the data connection between the current host and the target shared memory module, whereby the current host initializes the system management random access memory area corresponding to the system management mode code in the target shared memory module, and stores the system management mode code to the system management random access memory area.

In some embodiments, when the multi-host system starts, the current host may serve as the first startup host in the system, so the system management random access memory area needs to be initialized.

In the startup phase, the current host may send the system management mode code storage request to the switch. The request is configured for initializing the system management random access memory area in the shared memory module and storing the system management mode code. The switch may determine the target shared memory module among the plurality of shared memory modules based on the system management mode code storage request, and establish the data connection between the current host and the target shared memory module.

The switch may determine the target shared memory module based on the read-write performance, read-write priority, and storage capacity of each shared memory module. For example, the switch may evaluate the read-write performance of each shared memory module based on storage capacity and read-write speed, sort the shared memory modules in descending order based on evaluation values of the read-write performance of the shared memory modules, and determine the shared memory module at the head of the queue as the target shared memory module.

The current host initializes the system management random access memory area in the target shared memory module through the established data connection, and transfers the system management mode code from the memory module of the current host to the system management random access memory area after initialization. The memory module of the current host refers to the local memory of the current host.

According to the code sharing method provided in the embodiment of the present application, the switch may determine the target shared memory module among the plurality of shared memory modules, whereby the current host may initialize the system management random access memory area of the target shared memory module and store the system management mode code, and the following startup hosts may initialize the system management mode, thereby improving the utilization of memory resources in the multi-host system.

In some embodiments, after establishing a data connection between the current host and the target shared memory module, the method further includes:
storing location information of the target shared memory module in the plurality of shared memory modules and location information of the system management random access memory area in the target shared memory module; or
storing the location information of the target shared memory module in the plurality of shared memory modules and the location information of the system management random access memory area in the target shared memory module to a preset location in the plurality of shared memory modules.

In some embodiments, after establishing the data connection between the current host and the target shared memory module, the switch needs to store the location information of the target shared memory module in the plurality of shared memory modules and the location information of the system management random access memory area in the target shared memory module, whereby the hosts following the current host might quickly determine the storage location of the system management mode code when initializing the system management mode.

The location information of the target shared memory module in the plurality of shared memory modules and the location information of the system management random access memory area in the target shared memory module may be stored in the switch. Upon receiving the system management mode initialization request or system management mode code update request, the switch may quickly determine the storage location of the system management mode code based on the stored location information. In addition, the location information of the target shared memory module in the plurality of shared memory modules and the location information of the system management random access memory area in the target shared memory module may be stored to the preset location in the plurality of shared memory modules. For example, any shared memory module may be designated in the plurality of shared memory modules, and any random access memory area in that shared memory module may be designated as the preset location. The preset location is in some embodiments configured for storing the location information of the target shared memory module in the plurality of shared memory modules and the location information of the system management random access memory area in the target shared memory module.

According to the code sharing method provided in the embodiment of the present application, the location information of the target shared memory module in the plurality of shared memory modules and the location information of the system management random access memory area in the target shared memory module may be stored to the switch or the preset location in the plurality of shared memory modules, whereby the switch might quickly and accurately determine the storage location of the system management mode code, thereby improving the search efficiency of the system management mode code.

In some embodiments, the method further includes:
in response to a system management mode code update request sent by the current host in the multi-host system, determining the target shared memory module among the plurality of shared memory modules; and
establishing the data connection between the current host and the target shared memory module, whereby the current host updates the system management mode code in the system management random access memory area based on system management mode code in a memory module of the current host.

In some embodiments, the current host may serve as a code update host in the system to update the system management mode code in the system management random access memory area.

The current host may send the system management mode code update request to the switch. After parsing the received code update request, the switch establishes the data connection between the current host and the target shared memory module.

The current host may acquire first version information corresponding to the system management mode code in the system management random access memory area, and determine second version information corresponding to the system management mode code in the memory module of the current host. Based on a comparison result between the first version information and the second version information, whether to update the system management mode code in the system management random access memory area is determined.

According to the code sharing method provided in the embodiment of the present application, in response to the request from the current host, the switch establishes the data connection between the current host and the target shared memory module, whereby the current host may be configured to update the system management mode code in the target shared memory module, thereby improving the efficiency of updating the system management mode code and enhancing the utilization of memory resources in the multi-host system.

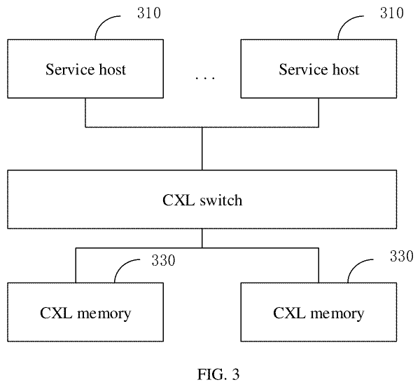

FIG. 3 is a system architecture diagram of a multi-host system provided in the present application. As shown in FIG. 3, the multi-host system includes a plurality of service hosts 310 (equivalent to the hosts in the above embodiments), a CXL switch 320 (equivalent to the switch in the above embodiments), and a plurality of CXL memories 330 (equivalent to the shared memory modules in the above embodiments). The service hosts, the CXL switch, and the CXL memories may be connected through a compute express link (CXL).

The CXL switch may configure a connection relationship between service hosts and CXL memories, thereby controlling the CXL memories that the service hosts might access.

The plurality of CXL memories constitute a memory pool. One of the CXL memories may be selected as a target CXL memory, a system management random access memory area is created for storing system management mode code, one service host initializes the system management random access memory area, and other service hosts may share and use the system management random access memory area and the system management mode code.

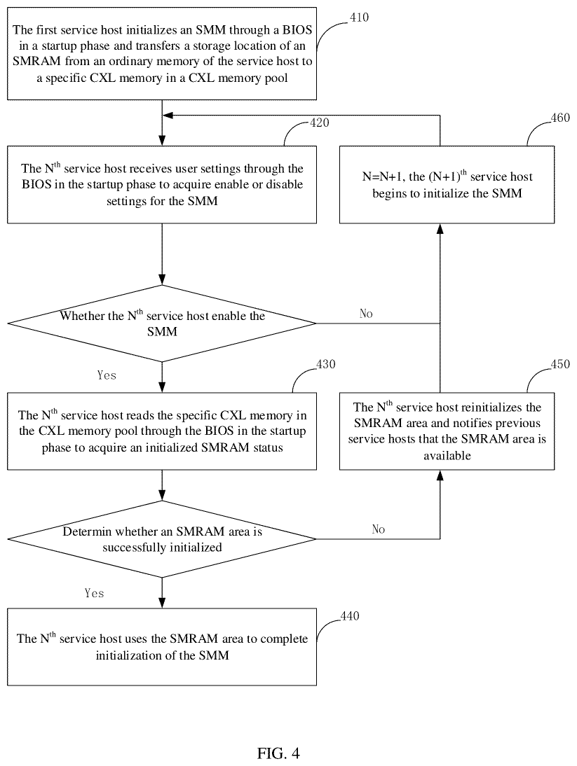

FIG. 4 is a schematic flowchart of a multi-host code sharing method provided in the present application. As shown in FIG. 4, the method includes steps 410, 420, 430, 440, 450, and 460.

For the convenience of describing the method, a plurality of service hosts may be numbered from 1 to N, where N is a natural number.

Step 410: The first service host is selected to initialize an SMM through a BIOS in a startup phase and transfer a storage location of an SMRAM from an ordinary memory (local memory) of the service host to a specific CXL memory (target CXL memory) in a CXL memory pool.

Step 420: The N^{th} service host receives user settings through the BIOS in the startup phase to acquire enable or disable settings for the SMM; if the SMM is enabled, step 430 will be performed; otherwise, step 460 will be performed.

Step 430: The N^{th} service host reads the specific CXL memory in the CXL memory pool through the BIOS in the startup phase to acquire an initialized SMRAM status and determines whether an SMRAM area is successfully initialized; if the SMRAM area is successfully initialized, step 440 will be performed; otherwise, step 450 will be performed.

Step 440: The N^{th} service host uses the SMRAM area to complete initialization of the SMM.

Step 450: The N^{th} service host reinitializes the SMRAM area and notifies previous service hosts that the SMRAM area is available.

Step 460: N=N+1, the (N+1)^{th} service host begins to initialize the SMM.

In the embodiment of the present application, the SMRAM is transferred from a local memory to a CXL memory module to change the storage location of the SMRAM area in the multi-service host system and then change the way that the plurality of service hosts access the SMM code. By using the characteristic that the plurality of service hosts may access the CXL memory module through the CXL switch, after one service host initializes the SMRAM, the other service hosts may use the SMRAM, thereby achieving the purpose of sharing the SMM code in the SMRAM among the plurality of service hosts, avoiding the problem of waste of memory resources due to the fact that the SMM code is stored in the local memory of each service host in conventional methods, and greatly improving memory utilization. In addition, when the SMM code needs to be updated, only one service host is required. The service host restarts, new SMM code is placed in the SMRAM area of the CXL memory module, and then other service hosts might view the updated SMM code, thereby greatly improving the efficiency of SMM code update.

The following describes an apparatus provided in the embodiments of the present application. The apparatus described below may be referred to the method described above.

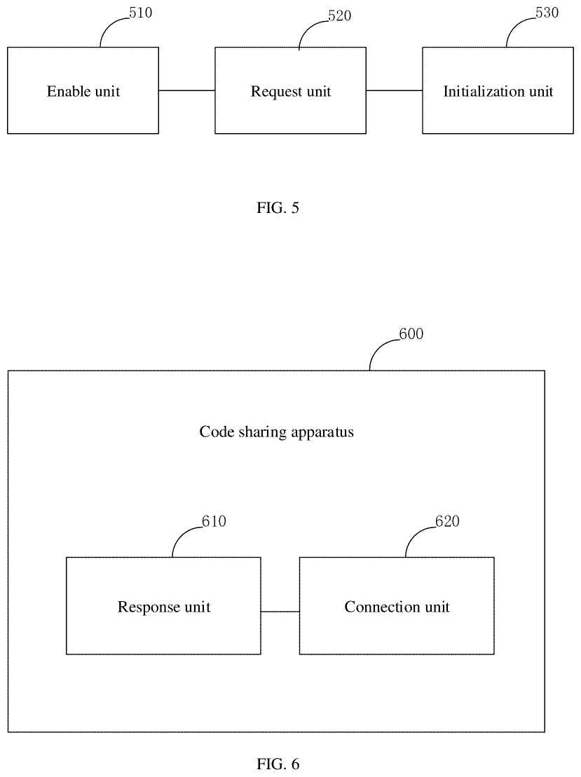

FIG. 5 is a first schematic structural diagram of a code sharing apparatus provided in the present application. As shown in FIG. 5, the apparatus is applied to hosts in a multi-host system and includes:
an enable unit 510, configured to determine to enable a system management mode of a current host;
a request unit 520, configured to send a system management mode initialization request to a switch in the multi-host system, where the switch is configured to determine, based on the system management mode initialization request, a target shared memory module for storing system management mode code among a plurality of shared memory modules in the multi-host system, and a system management random access memory area corresponding to the system management mode code in the target shared memory module, and establish a data connection between the current host and the target shared memory module; and
an initialization unit 530, configured to initialize the system management mode of the current host based on the system management mode code.

The code sharing apparatus provided in the embodiment of the present application, applied to the host in the multi-host system, determines to enable the system management mode of the current host; sends the system management mode initialization request to the switch in the multi-host system, where the switch is configured to determine, based on the system management mode initialization request, the target shared memory module for storing system management mode code among the plurality of shared memory modules in the multi-host system, and the system management random access memory area corresponding to the system management mode code in the target shared memory module, and establish the data connection between the current host and the target shared memory module; and initializes the system management mode of the current host based on the system management mode code. Since the shared memory modules are configured in the multi-host system and the system management mode code is stored in the shared memory modules, each host may access and initialize the system management mode, and the same code does not need to be stored in the local memory of each host, thereby saving memory resources in the multi-host system, avoiding waste of memory resources, and improving the utilization of memory resources in the multi-host system. Meanwhile, the quantity and capacity of the shared memory modules may be flexibly configured according to the needs of the multi-host system, thereby reducing hardware configuration costs of the multi-host system.

In some embodiments, the initialization unit is configured to:
acquire an initialization detection result of the system management random access memory area;
when the initialization detection result is initialized, read the system management mode code in the system management random access memory area;
verify the system management mode code; and
when a verification result of the system management mode code is passed, load the system management mode code to initialize the system management mode of the current host.

In some embodiments, the initialization unit is further configured to:
when the initialization detection result is uninitialized, initialize the system management random access memory area; and
send system management random access memory area initialization information to the hosts before the current host in a startup sequence.

In some embodiments, the apparatus is further configured to:
send a system management mode code storage request to the switch, where the switch is configured to establish the data connection between the current host and the target shared memory module based on the system management mode code storage request; and
initialize the system management random access memory area in the target shared memory module, and transfer the system management mode code from a memory module of the current host to the system management random access memory area.

In some embodiments, the apparatus is further configured to:
send a system management mode code update request to the switch, where the switch is configured to establish the data connection between the current host and the target shared memory module based on the system management mode code update request; and
update the system management mode code in the system management random access memory area based on system management mode code in a memory module of the current host.

In some embodiments, at least two hosts in the multi-host system use the same system management mode code.

FIG. 6 is a second schematic structural diagram of a code sharing apparatus provided in the present application. As shown in FIG. 6, the code sharing apparatus 600 is applied to a switch in a multi-host system and includes:
a response unit 610, configured to, in response to a system management mode initialization request sent by a current host in the multi-host system, determine a target shared memory module for storing system management mode code among a plurality of shared memory modules, and a system management random access memory area corresponding to the system management mode code in the target shared memory module; and
a connection unit 620, configured to establish a data connection between the current host and the target shared memory module, whereby the current host initializes a system management mode based on the system management mode code.

The code sharing apparatus provided in the embodiments of the present application, applied to the switch in the multi-host system, in response to the system management mode initialization request sent by the current host in the multi-host system, determines the target shared memory module for storing system management mode code among the plurality of shared memory modules, and the system management random access memory area corresponding to the system management mode code in the target shared memory module; and establishes the data connection between the current host and the target shared memory module, whereby the current host initializes the system management mode based on the system management mode code. Since the shared memory modules are configured in the multi-host system and the system management mode code is stored in the shared memory modules, each host may access and initialize the system management mode, and the same code does not need to be stored in the local memory of each host, thereby saving memory resources in the multi-host system, avoiding waste of memory resources, and improving the utilization of memory resources in the multi-host system. Meanwhile, the quantity and capacity of the shared memory modules may be flexibly configured according to the needs of the multi-host system, thereby reducing hardware configuration costs of the multi-host system.

In some embodiments, the apparatus is further configured to:
in response to a system management mode code storage request sent by the current host in the multi-host system, determine the target shared memory module among the plurality of shared memory modules; and
establish the data connection between the current host and the target shared memory module, whereby the current host initializes the system management random access memory area corresponding to the system management mode code in the target shared memory module, and stores the system management mode code to the system management random access memory area.

In some embodiments, the apparatus is further configured to:
store location information of the target shared memory module in the plurality of shared memory modules and location information of the system management random access memory area in the target shared memory module; or
store the location information of the target shared memory module in the plurality of shared memory modules and the location information of the system management random access memory area in the target shared memory module to a preset location in the plurality of shared memory modules.

In some embodiments, the apparatus is further configured to:
in response to a system management mode code update request sent by the current host in the multi-host system, determine the target shared memory module among the plurality of shared memory modules; and
establish the data connection between the current host and the target shared memory module, whereby the current host updates the system management mode code in the system management random access memory area based on system management mode code in a memory module of the current host.

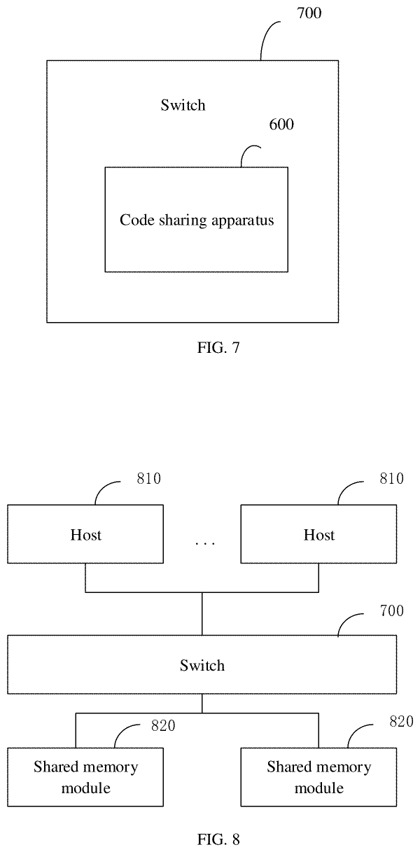

FIG. 7 is a schematic structural diagram of a switch provided in the present application. As shown in FIG. 7, the switch 700 includes a code sharing apparatus 600.

The switch provided in the embodiment of the present application, applied to a multi-host system, includes the code sharing apparatus in the foregoing embodiments, each host may access and initialize the system management mode, and the same code does not need to be stored in the local memory of each host, thereby saving memory resources in the multi-host system, avoiding waste of memory resources, and improving the utilization of memory resources in the multi-host system. Meanwhile, the quantity and capacity of the shared memory modules may be flexibly configured according to the needs of the multi-host system, thereby reducing hardware configuration costs of the multi-host system.

In some embodiments, the switch further includes a control unit, a plurality of upstream ports, and a plurality of downstream ports.

The plurality of upstream ports are connected to a plurality of hosts in one-to-one correspondence.

The plurality of downstream ports are connected to a plurality of shared memory modules in one-to-one correspondence.

The control unit is connected to the plurality of upstream ports and the plurality of downstream ports to establish data connections between the hosts and the shared memory modules.

In some embodiments, the switch may include a control unit, as well as a plurality of upstream ports and a plurality of downstream ports connected to the control unit.

The upstream ports are connected to the hosts in one-to-one correspondence, and the downstream ports are connected to the shared memory modules in one-to-one correspondence. The control unit is mainly configured to, in response to a request of each host, establish data connections between the hosts and the shared memory modules.

According to the switch provided in the embodiment of the present application, the hosts are connected to the upstream ports and the downstream ports to establish data connections between the hosts and the shared memory modules, whereby each host may access different shared memory modules as needed, thereby saving memory resources in the multi-host system, avoiding waste of memory resources, and improving the utilization of memory resources in the multi-host system. Meanwhile, the quantity and capacity of the shared memory modules may be flexibly configured according to the needs of the multi-host system, thereby reducing hardware configuration costs of the multi-host system.

In some embodiments, the control unit is further configured to:
determine read-write performance evaluation values of the shared memory modules; and
determine a target shared memory module among the plurality of shared memory modules based on the read-write performance evaluation values of the shared memory modules.

In some embodiments, the read-write performance evaluation values are configured for evaluating the read-write performance of the shared memory modules. The higher the read-write performance evaluation value, the better the read-write performance of the shared memory module.

When the target shared memory module is determined among the plurality of shared memory modules, the switch may determine the target shared memory module based on the read-write performance, read-write priority, and storage capacity of each shared memory module. For example, the switch may evaluate the read-write performance of each shared memory module based on storage capacity and read-write speed, sort the shared memory modules in descending order based on evaluation values of the read-write performance of the shared memory modules, and determine the shared memory module at the head of the queue as the target shared memory module.

According to the switch provided in the embodiment of the present application, the target shared memory module is determined based on the read-write performance evaluation values of the shared memory modules, thereby improving the read-write efficiency of the system management code.

In some embodiments, the control unit supports a compute express link.

In some embodiments, the compute express link (CXL) is a high-speed interconnect protocol that combines the characteristics of memory and device interconnection, and may be configured to connect a processor, an accelerator, a storage device, and other external devices to implement efficient data transmission and sharing, so as to provide high-performance and low-latency communication between various components within a computer system.

According to the switch provided in the embodiment of the present application, the control unit supports the compute express link, enabling high-performance and low-latency communication between hosts and shared memory modules.

FIG. 8 is a schematic structural diagram of a multi-host system provided in the present application. As shown in FIG. 8, the multi-host system includes a switch 700, a plurality of hosts 810, and a plurality of shared memory modules 820. The switch is connected to the plurality of hosts and the plurality of shared memory modules.

The host is configured to perform the code sharing method applied to a host side in the multi-host system in the foregoing embodiments. The switch is configured to perform the code sharing method applied to a switch side in the multi-host system in the foregoing embodiments.

The multi-host system provided in the embodiment of the present application includes the shared memory modules, and the system management mode code is stored to the shared memory modules, whereby each host may access and initialize the system management mode, and the same code does not need to be stored in the local memory of each host, thereby saving memory resources in the multi-host system, avoiding waste of memory resources, and improving the utilization of memory resources in the multi-host system. Meanwhile, the quantity and capacity of the shared memory modules may be flexibly configured according to the needs of the multi-host system, thereby reducing hardware configuration costs of the multi-host system.

In some embodiments, the switch is connected to the plurality of hosts and the plurality of shared memory modules based on a compute express link.

According to the multi-host system provided in the embodiment of the present application, the hosts, the switch, and the shared memory modules are connected through the compute express link, enabling high-performance and low-latency communication, thereby improving the read-write efficiency of shared code.

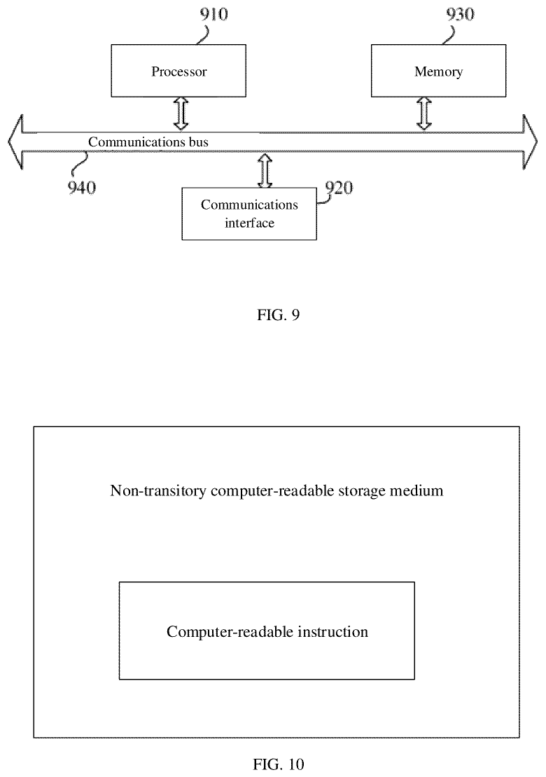

FIG. 9 is a schematic structural diagram of an electronic device provided in the present application. As shown in FIG. 9, the electronic device may include a processor 910, a communications interface 920, a memory 930, and a communications bus 940. The processor 910, the communications interface 920, and the memory 930 communicate with each other through the communications bus 940. The processor 910 may call a logical command in the memory 930 to perform the method described in the foregoing embodiments, for example:
determining to enable a system management mode of a current host; sending a system management mode initialization request to a switch in a multi-host system, where the switch is configured to determine, based on the system management mode initialization request, a target shared memory module for storing system management mode code among a plurality of shared memory modules in the multi-host system, and a system management random access memory area module corresponding to the system management mode code in the target shared memory module, and establish a data connection between the current host and the target shared memory module; and initializing the system management mode of the current host based on the system management mode code; or
in response to a system management mode initialization request sent by a current host in a multi-host system, determining a target shared memory module for storing system management mode code among a plurality of shared memory modules, and a system management random access memory area corresponding to the system management mode code in the target shared memory module; and establishing a data connection between the current host and the target shared memory module, whereby the current host initializes a system management mode based on the system management mode code.

In addition, the foregoing logical command in the memory, when implemented in a form of software functional units and sold or used as an independent product, may be stored in a computer-readable storage medium. Based on such an understanding, the technical solution of the present application essentially or a part contributing to the related art or a part of the technical solution may be embodied in a form of a software product. The computer software product is stored in a storage medium, and includes a plurality of commands to enable a computer device (which may be a personal computer, a server, a network device, or the like) to perform all or part of the steps of the method in one or more embodiments of the present application. The foregoing storage medium includes various media that may store program code, such as a USB flash drive, a mobile hard disk, a read-only memory (ROM), a random access memory (RAM), a magnetic disk, or an optical disk.

The processor in the electronic device provided in the embodiment of the present application may call logical instructions in the memory to implement the foregoing method. The specific implementation is consistent with the implementation of the foregoing method and might achieve the same beneficial effects. Details will not be repeated here.

With reference to FIG. 10, an embodiment of the present application further provides a non-transitory computer-readable storage medium, having computer-readable instructions stored therein, the computer-readable instructions, when executed by a processor, implementing the method provided in the foregoing embodiments.

The specific implementation is consistent with the implementation of the foregoing method and might achieve the same beneficial effects. Details will not be repeated here.

An embodiment of the present application further provides a computer program product, including computer-readable instructions, the computer-readable instructions, when executed by a processor, implementing the foregoing method.

The apparatus embodiment described above is merely illustrative. The units described as separate components may or may not be physically separated, and the components displayed as units may or may not be physical units, that is, the units or components may be located in one place or distributed to a plurality of network units. Some or all of the modules may be selected according to actual needs to achieve the objectives of the solutions of the embodiments. A person skilled in the art may understand and implement the embodiments without creative efforts.

Through the description of the above implementations, a person skilled in the art may clearly understand that each embodiment may be implemented by software and a necessary universal hardware platform or by hardware. Based on such an understanding, the foregoing technical solution essentially or a part contributing to the related art may be embodied in a form of a software product. The computer software product may be stored in a computer-readable storage medium, such as an ROM/RAM, a magnetic disk, or an optical disk, and includes a plurality of instructions to enable a computer device (which may be a personal computer, a server, a network device, or the like) to perform the method described in one or more embodiments or some parts of the embodiments.

Finally, it should be noted that the above embodiments are merely used for explaining the technical solutions of the present application, rather than limiting the present application. Although the present application is described in detail with reference to the foregoing embodiments, a person skilled in the art should understand that modifications may still be made to the technical solutions described in the embodiments or equivalent replacements to some technical features therein; and these modifications replacements do not make the essences of the corresponding technical solutions depart from the spirit and scope of the technical solutions of the embodiments of the present application.

1. A code sharing method, being applied to hosts in a multi-host system and comprising:
determining to enable a system management mode of a current host;
sending a system management mode initialization request to a switch in the multi-host system, wherein the switch is configured to determine, based on the system management mode initialization request, a target shared memory module for storing system management mode code among a plurality of shared memory modules in the multi-host system, and a system management random access memory area corresponding to the system management mode code in the target shared memory module, and establish a data connection between the current host and the target shared memory module; and
initializing the system management mode of the current host based on the system management mode code; wherein
the initializing the system management mode of the current host based on the system management mode code comprises:
acquiring an initialization detection result of the system management random access memory area;
when the initialization detection result is initialized, reading the system management mode code in the system management random access memory area;
verifying the system management mode code; and
when a verification result of the system management mode code is passed, loading the system management mode code to initialize the system management mode of the current host.

2. (canceled)

3. The code sharing method according to claim 1, wherein after the acquiring an initialization detection result of the system management random access memory area, the method further comprises:
when the initialization detection result is uninitialized, initializing the system management random access memory area; and
sending system management random access memory area initialization information to the hosts before the current host in a startup sequence.

4. The code sharing method according to claim 1, wherein the method further comprises:
sending a system management mode code storage request to the switch, wherein the switch is configured to establish the data connection between the current host and the target shared memory module based on the system management mode code storage request; and
initializing the system management random access memory area in the target shared memory module, and transferring the system management mode code from a memory module of the current host to the system management random access memory area.

5. The code sharing method according to claim 1, wherein the method further comprises:
sending a system management mode code update request to the switch, wherein the switch is configured to establish the data connection between the current host and the target shared memory module based on the system management mode code update request; and
updating the system management mode code in the system management random access memory area based on system management mode code in a memory module of the current host.

6. The code sharing method according to claim 1, wherein at least two hosts of the hosts in the multi-host system use a same system management mode code.

7. A code sharing method, being applied to a switch in a multi-host system and comprising:
in response to a system management mode initialization request sent by a current host in the multi-host system, determining a target shared memory module for storing system management mode code among a plurality of shared memory modules, and a system management random access memory area corresponding to the system management mode code in the target shared memory module; and
establishing a data connection between the current host and the target shared memory module, whereby the current host initializes a system management mode based on the system management mode code; and
wherein the current host is configured for:
acquiring an initialization detection result of the system management random access memory area;
when the initialization detection result is initialized, reading the system management mode code in the system management random access memory area;
verifying the system management mode code; and
when a verification result of the system management mode code is passed, loading the system management mode code to initialize the system management mode of the current host.

8. The code sharing method according to claim 7, wherein the method further comprises:
in response to a system management mode code storage request sent by the current host in the multi-host system, determining the target shared memory module among the plurality of shared memory modules; and
establishing the data connection between the current host and the target shared memory module, whereby the current host initializes the system management random access memory area corresponding to the system management mode code in the target shared memory module and stores the system management mode code to the system management random access memory area.

9. The code sharing method according to claim 8, wherein after the establishing the data connection between the current host and the target shared memory module, the method further comprises:
storing location information of the target shared memory module in the plurality of shared memory modules and location information of the system management random access memory area in the target shared memory module; or
storing the location information of the target shared memory module in the plurality of shared memory modules and the location information of the system management random access memory area in the target shared memory module to a preset location in the plurality of shared memory modules.

10. The code sharing method according to claim 7, wherein the method further comprises:
in response to a system management mode code update request sent by the current host in the multi-host system, determining the target shared memory module among the plurality of shared memory modules; and
establishing the data connection between the current host and the target shared memory module, whereby the current host updates the system management mode code in the system management random access memory area based on system management mode code in a memory module of the current host.

11. -12. (cancelled)

13. A switch in a multi-host system, comprising a code sharing apparatus, the code sharing apparatus comprising:
a response unit, configured to, in response to a system management mode initialization request sent by a current host in the multi-host system, determine a target shared memory module for storing system management mode code among a plurality of shared memory modules, and a system management random access memory area corresponding to the system management mode code in the target shared memory module; and
a connection unit, configured to establish a data connection between the current host and the target shared memory module, whereby the current host initializes a system management mode based on the system management mode code; and
wherein the current host is configured for:
acquiring an initialization detection result of the system management random access memory area;
when the initialization detection result is initialized, reading the system management mode code in the system management random access memory area;
verifying the system management mode code; and
when a verification result of the system management mode code is passed, loading the system management mode code to initialize the system management mode of the current host.

14. The switch according to claim 13, further comprising a control unit, a plurality of upstream ports, and a plurality of downstream ports,
wherein the plurality of upstream ports are connected to a plurality of hosts in one-to-one correspondence;
the plurality of downstream ports are connected to the plurality of shared memory modules in one-to-one correspondence; and
the control unit is connected to the plurality of upstream ports and the plurality of downstream ports to establish data connections between the hosts and the plurality of shared memory modules.

15. The switch according to claim 14, wherein the control unit is further configured to:
determine read-write performance evaluation values of the plurality of shared memory modules; and
determine the target shared memory module among the plurality of shared memory modules based on the read-write performance evaluation values of the plurality of shared memory modules.

16. The switch according to claim 15, wherein the control unit supports a compute express link.

17. A multi-host system, comprising a switch, a plurality of hosts, and a plurality of shared memory modules, wherein the switch is connected to the plurality of hosts and the plurality of shared memory modules;
the host is configured to perform the code sharing method according to claim 1; and
the switch is configured to perform a code sharing method comprising:
in response to a system management mode initialization request sent by a current host in the multi-host system, determining a target shared memory module for storing system management mode code among a plurality of shared memory modules, and a system management random access memory area corresponding to the system management mode code in the target shared memory module; and
establishing a data connection between the current host and the target shared memory module, whereby the current host initializes a system management mode based on the system management mode code; and
wherein the current host is configured for:
acquiring an initialization detection result of the system management random access memory area;
when the initialization detection result is initialized, reading the system management mode code in the system management random access memory area;
verifying the system management mode code; and
when a verification result of the system management mode code is passed, loading the system management mode code to initialize the system management mode of the current host.

18. The multi-host system according to claim 17, the switch is connected to the plurality of hosts and the plurality of shared memory modules based on a compute express link.

19. An electronic device, comprising a memory, a processor, and computer-readable instructions stored in the memory and executable on the processor, the processor, when executing the computer-readable instructions, is configured to perform the code sharing method according to claim 1.

20. A non-transitory computer-readable storage medium, having computer-readable instructions stored therein, the computer-readable instructions, when executed by a processor, are configured to perform the code sharing method according to claim 1.

21. The code sharing method according to claim 1, the determining to enable a system management mode of a current host comprises:
determining to enable or disable the system management mode of the current host by inputting setting information in a basic input output system (BIOS) upon startup of the current host.

22. The code sharing method according to claim 1, wherein the initializing the system management mode of the current host based on the system management mode code comprises:
upon startup of the current host, detecting and configuring system management mode functions via a basic input output system (BIOS), enabling the system management mode by configuring a corresponding register and flag, and ensuring that a processor is capable of entering a system management mode operating mode.
